(19) United States
(12) Patent Application Publication
(10) Pub. No.: US 2011/0097559 A1
(43) Pub. Date: Apr. 28, 2011

(54) SUPRAMOLECULAR BLOCK COPOLYMER COMPOSITIONS FOR SUB-MICRON LITHOGRAPHY

(76) Inventors: Craig J. Hawker, Santa Barbara, CA (US); Chuanbing Tang, Santa Barbara, CA (US); Edward J. Kramer, Santa Barbara, CA (US); Glenn Fredrickson, Santa barbara, CA (US)

(21) Appl. No.: 12/990,941

(22) PCT Filed: May 7, 2009
(86) PCT No.: PCT/US09/43113

§ 371 Date: Dec. 15, 2010

Related U.S. Application Data
(60) Provisional application No. 60/126,959, filed on Mar. 30, 1999.

(51) Int. Cl. B32B 3/30; C08L 53/00; B29C 41/12; G03G 13/14

(52) U.S. Cl. 428/195.1; 525/89; 264/309; 216/52

(57) ABSTRACT

A polymeric composition and method of preparation for application in sub-micron lithography, comprising a blend of A-B and B′-C block, random, branched, or graft copolymers, where: (i) the B and B′ blocks or grafts have attractive supramolecular interactions characterized by a negative Flory-Huggins parameter; (ii) the composition exhibits a microphase-separated, three-domain morphology with A, C, and B/B′ domains comprised largely of A blocks or grafts, C blocks or grafts, and a mixture of B and B′ blocks or grafts, respectively. Long-range ordering of nanometer-scale domain features has been achieved in thin films of such supramolecular polymer blends, while avoiding macrophase separation. The strategy offers a diversity of morphologies for sub-micron lithographic applications in tandem with ease of chemical synthesis.

### CROSS-REFERENCE TO RELATED APPLICATIONS

This application claims the benefit of Provisional Patent Application No. 61/126,959 filed on May 8, 2008, which is incorporated by reference herein.

### STATEMENT REGARDING FEDERALLY SPONSORED RESEARCH OR DEVELOPMENT

This invention was made with support of Nanoelectronics Research Initiative (NRI), a company consortium established by Semiconductor Research Corporation (SRC), under Grant RID#1549 (SRC/NRI). The SRC has certain rights in this invention.

### FIELD OF THE INVENTION

The invention relates to polymeric compositions for sub-micron lithography.

### BACKGROUND OF THE INVENTION

The manufacture and miniaturization of integrated circuit components has made possible the operation of microprocessors at gigahertz frequencies as well as achieving gigabit capacities in dynamic random access memory (DRAM)¹. However, one of the main future limitations for this technology is the inability to continue scaling to smaller dimensions the photolithographic techniques currently employed in complimentary metal oxide semiconductor (CMOS) transistors². One promising technique to achieve this desired device miniaturization is Block Copolymer (BCP) lithography^{3,4}. BCP lithography involves a self-assembly process that affords well-ordered patterns with domain sizes and periods ranging from 5 to 100 nm over large areas with relative ease and speed. It has been previously used to fabricate ordered arrays of cobalt, silicon and silicon oxide^{5,6}. However to replace photolithography with BCP lithography, two major challenges are the achievement of long-range ordering from self-assembly of the BCP coupled with the elucidation of strategies for producing a wide range of symmetrical and non-symmetrical nanopatterns. Long-range ordering in thin films has been achieved with A-B, A-B-A or A-B-C block copolymers, and in specially designed mixtures of A-B block copolymers and C homopolymers⁷⁻⁹. However, no long-range ordering has been achieved in thin film mixtures of two chemically dissimilar block copolymers, because such mixtures tend to exhibit macrophase separation.

### BRIEF SUMMARY OF THE INVENTION

The present invention overcomes the foregoing drawbacks by providing a broad strategy that allows for the development of polymeric compositions for sub-micron lithography comprising a mixture of an A-B block or graft copolymer and a B′-C block or graft copolymer with a controlled microphase separated, three-domain structure. Through attractive supramolecular interactions between B and B′ blocks or grafts, this blended system exhibits microphases similar to ABC triblock copolymers, thus having advantages of diverse morphology, but avoids the rigorous synthesis of ABC triblock copolymers, just requiring synthesis of simpler binary A-B and B′-C copolymers. The attractive interactions between B and B′ segments, described by a negative Flory interaction parameter, can be achieved by a variety of supramolecular interactions such as hydrogen bonding (e.g. complexation between poly(4-vinylpyridine) and poly(4-hydroxystyrene)), π-πstacking (e.g. backbone stacking of polyphenylenevinylene, or poly(3-hexylthiophene)), metal coordination (e.g. terpyridine-metal ion bridging different polymer blocks), etc.

The present invention provides an entirely new approach to develop self-assembled nanoscale patterns for use in sub-micron lithography. The invention provides access to the diverse morphologies that ABC triblock copolymers offer, but only requires the synthesis of binary A-B and B′-C block or graft copolymers. Successful implementation of such sub-micron lithographic techniques could enable the fabrication of >10¹⁰ devices on a chip in a low-cost and multifunctional manner.

More particularly, a method is provided for preparing a polymeric composition, comprising a supramolecularly interacting blend of A-B and B′-C block or graft copolymers, wherein:

(i) said A-B block or graft copolymer is itself a mixture of one or more A-B block or graft copolymers, each with at least one polymerized block or graft of polymer A and at least one polymerized block or graft of polymer B;

(ii) said B′-C block or graft copolymer is itself a mixture of one or more B′-C block or graft copolymers, each with at least one polymerized block or graft of polymer B′ and at least one polymerized block or graft of polymer C;

(iii) the B blocks or grafts of the A-B component have attractive interactions with the B′ blocks or grafts of the B′-C component, such interactions being described by a negative Flory-Huggins parameter χ_{BB′}; and

(iv) the composition exhibits a microphase-separated, three-domain morphology with distinct A, C, and B/B′ domains comprised largely of A polymer segments, C polymer segments, and a mixture of B and B′ polymer segments, respectively.

In another embodiment, the A-B block or graft copolymer can be an A-B diblock copolymer and the B′-C block or graft copolymer can be a B′-C diblock copolymer.

In specific embodiments, the blocks or grafts A, B, B′, and C can each bear a group selected from olefins, conjugated dienes, methacrylates, styrenes, acrylates, acrylamides, and acrylonitriles, esters, ethers, urethanes, ureas, amides, and statistical copolymers thereof. In another embodiment, the B and B′ blocks or grafts are themselves random or statistical copolymers of a common monomer, along with comonomers that bear the functional groups responsible for the attractive supramolecular interaction.

Thin films of these blended block copolymer systems can be treated so as to achieve long-range orientational and positional ordering of microdomains at a macroscopic scale. Given the simplicity of binary A-B and B′-C copolymer synthesis and the diverse set of morphologies that can be achieved by blending such materials, this method significantly broadens the scope of block copolymer lithography.

### BRIEF DESCRIPTION OF THE DRAWINGS

For a more complete understanding of the present invention, reference is now made to the following descriptions taken in conjunction with the accompanying drawing, in which:

FIG. 1 illustrates a scheme for microphase separation of A-B and B′-C diblock copolymer blends through supramolecular interaction of B and B′ segments with a negative Flory-Huggins parameter;

FIG. 2 depicts one example of synthesis of A-B and B′-C diblock copolymers;

FIG. 3 shows AFM images of hexagonal (left) and square (right) packing of microdomain features in thin films of an A-B and B′-C blended system; and

FIG. 4 shows SEM images of hexagonal (left) and square (right) packing of microdomain features in thin films of an A-B and B′-C blended system.

### DETAILED DESCRIPTION OF THE INVENTION

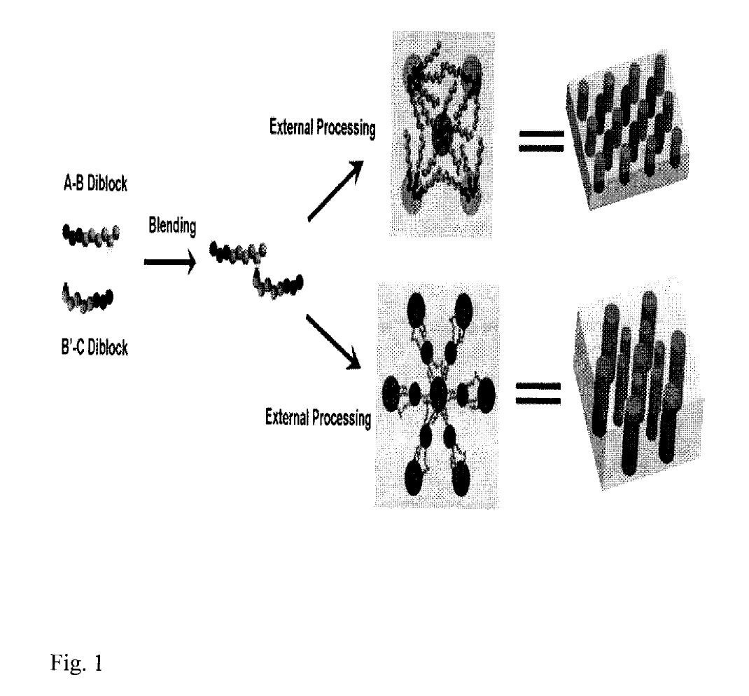

We have demonstrated a novel route that allows blends of two block copolymers to avoid macrophase separation and achieve long-range ordering in thin films. Self-assembly of this system leads to a rich array of highly ordered and geometrically diverse microphase separated structures, such as microdomain arrays with hexagonal packing, square packing, or a mixture of both. This system can be used as a lithographic mask to achieve ordered nanopillars or nanopores with preservation of its precursor structures. The size of the ordered features is primarily in the range of 5-20 nm but can be larger or smaller. The novel method involves a polymeric composition comprising a mixture of an A-B block or graft copolymer and a B′-C block or graft copolymer with a microphase-separated, three-domain structure in which the B and B′ segments are bound together into a mixed B/B′ domain through attractive supramolecular interactions characterized by a negative Flory-Huggins parameter. FIG. 1 illustrates a scheme for one particular embodiment—the case of an A-B and B′-C diblock copolymer blend with attractive supramolecular interactions among the B and B′ segments. This blended system provides access to the microphase structures of ABC triblock copolymers, thus having the advantage of diverse morphology (highly desirable in the microelectronics area and not achievable with simple AB block copolymers), but avoids the rigorous synthesis of ABC triblock copolymers. Only binary A-B and B′-C copolymers need to be synthesized. Negative Flory-Huggins interaction parameters can be achieved by many types of supramolecular interactions such as hydrogen bonding, π-π stacking, metal coordination, etc. The method presented in this invention offers the following key features:
1. The interactions between segments of the B and B′ blocks or grafts are attractive, which can be described by a negative Flory-Huggins interaction parameter χ_{BB′}.
2. The composition microphase separates to produce a three-domain structure with
   a. A domains comprised largely of A block or graft segments;
   b. C domains comprised largely of C block or graft segments; and
   c. B/B′ domains comprised largely of a mixture of B and B′ block or graft segments.
3. The A, B/B′, and C domains can be either discrete or continuous.
4. The A, B/B′, and/or C domains can be removed from the composition by a suitable chemical and/or physical treatment.
5. Macrophase separation of the A-B and B′-C block or graft copolymers is avoided due to the supramolecular attraction between the B and B′ blocks or grafts.
   The Flory-Huggins parameter χ_{BB′} is a parameter known in the polymer science literature that describes the tendency for polymer segments of types B and B′ to mix. Generally, the lower the value of χ_{BB′}, the better the miscibility of B and B′ polymer segments. A negative value of χ_{BB′} is known to promote strong mixing of B and B′ block segments.

An example of such a system is described below.

### Example 1

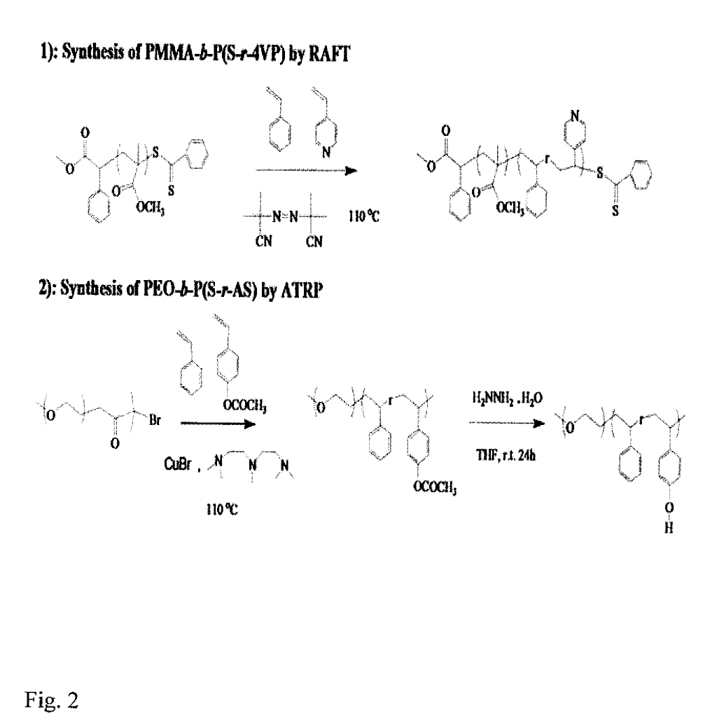

We prepared and blended the two diblock copolymers poly(methyl methacrylate)-b-poly(styrene-r-4-vinylpyridine) (PMMA-b-P(S-r-4VP)) and poly(ethylene oxide)-b-poly(styrene-r-4-hydroxystyene) (PEO-b-P(S-r-HS)) in order to illustrate the invention. This blended system combines the readily-achievable long-range order offered by PEO segments in PEO-PS diblock copolymers and the photodegradability of PMMA segments in PMMA-PS diblock copolymers. 4-vinylpyridine has an attractive supramolecular interaction with 4-hydroxystyrene through hydrogen bonding, which drives the P(S-r-4VP) and P(S-r-HS) blocks to mix into a common B/B′ domain, avoiding macrophase separation. The synthesis of PMMA-b-P(S-r-4 VP) as the A-B diblock copolymer and PEO-b-P(S-r-HS) as the C-B′ diblock copolymer was accomplished as shown in FIG. 2 by reversible addition-fragmentation chain transfer (RAFT) polymerization and atom transfer radical polymerization (ATRP) respectively. Addition of styrene and 4-vinylpyridine to macroinitiator PMMA yielded the desired PMMA-b-P(S-r-4VP), the desired A-B diblock copolymer. PEO ATRP initiators were chain extended with a mixture of styrene and acetoxystyrene (AS), resulting in a PEO-b-P(S-r-HS) diblock copolymer. Subsequent hydrolysis of acetoxystyrene under hydrazine solution converted polyacetoxystyrene into polyhydroxystyrene, yielding PEO-b-P(S-r-HS) as the desired C-B′ diblock copolymer.

### Example 2

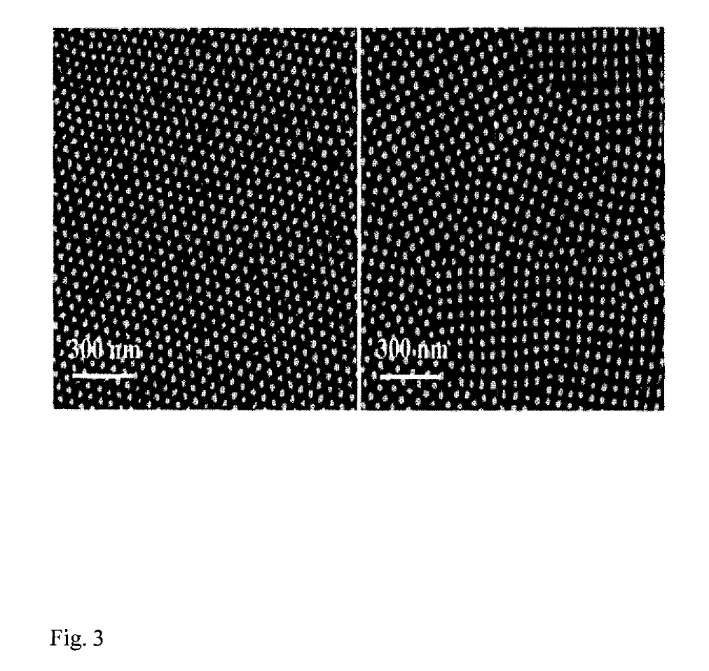

A method to achieve long-range ordering for the above specific system is to utilize solvent-annealing under controlled humidity conditions. The processing is very simple and fast and does not require expensive instrumentation. The above A-B and B′-C diblock copolymers were blended, dissolved in benzene and then spin-coated onto substrates such as silicon wafers followed by solvent annealing under controlled humidity. No macrophase separation was observed. FIG. 3 shows the formation of microphases consisting of hexagonal and square arrays of cylindrical domains. The cylinders align perpendicular to the substrate and the film surface and span the whole wafer. This procedure allows for the creation of hexagonal or square arrays of cylindrical domains with low concentrations of defects over large areas. Solvent annealing with these blended polymers produced a mixed poly(styrene-r-4-vinylpyridine) and poly(styrene-r-4-hydroxystyene) (B/B′) matrix with separated A and C cylinders comprised of PMMA blocks and PEO blocks, respectively. By controlling the molecular weight of each block, the size of the ordered domains can be tuned within to be between 1 and 50 nm, preferably 5-20 nm.

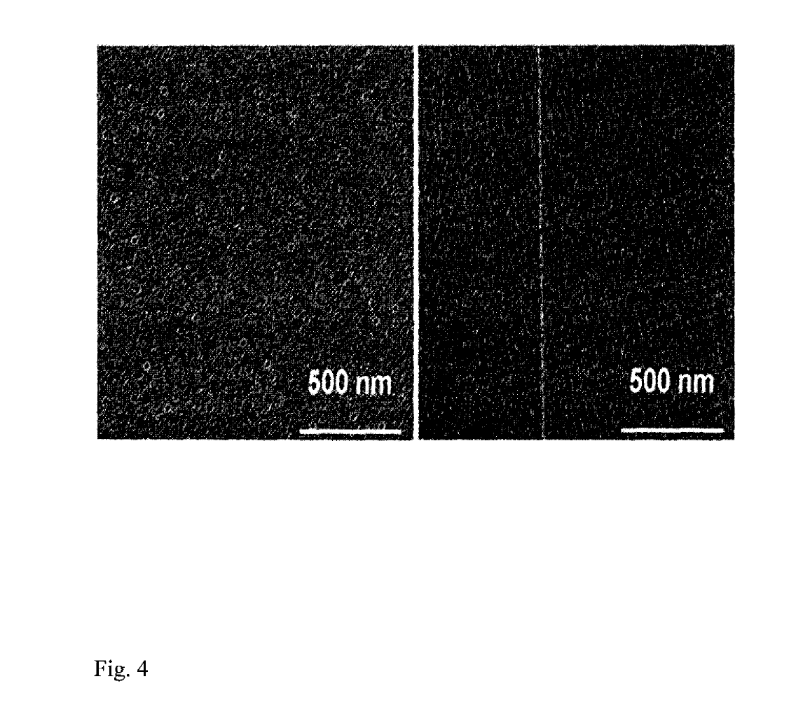

Nanoporous films can be obtained by removing the PMMA domains under UV light irradiation and simultaneously cross-linking the PS matrix. FIG. 4 shows scanning electron microscope (SEM) images of the resulting nanoporous thin films. Clearly, the hexagonal and square ordering was preserved. The darker regions correspond to the pores, which originate from the degraded PMMA domains.

This work shows the potential for many other block copolymer systems to be applied in a similar fashion to obtain ordered films. Among many possible functional groups, polymers bearing the following groups are particularly attractive: olefins, conjugated dienes, methacrylates, styrenes, acrylates, acrylamides, and acrylonitriles. In these systems, macrophase separation can be suppressed as long as the B and B′ segments have a negative Flory-Huggins interaction parameter. Additional processing techniques, such as thermal annealing, neutral surfaces, chemical modified substrates, and graphoepitaxy, can be applied to improve the quality of the lateral in-plane order of the microdomains, the details of which depend on the type of polymers chosen. The use of an ultra-thin (1-10 nm) crosslinked neutralization layer and low molecular weight materials (e.g. in the range of 1,000 to 50,000 g/mol) may also lead to the fabrication of feature sizes in the 1-50 nm and preferably 5-20 nm range over a variety of homogeneous and heterogeneous surfaces¹⁰.

The strategy described here not only offers the diversity of morphologies seen in ABC triblock copolymers, but also requires only the synthesis of diblock copolymers. We envision that the successful implementation of such sub-micron lithographic techniques could enable the fabrication of >10¹⁰ devices on a chip in a low-cost and multifunctional manner.

Although the present invention has been described in connection with the preferred embodiments, it is to be understood that modifications and variations may be utilized without departing from the principles and scope of the invention, as those skilled in the art will readily understand. Accordingly, such modifications may be practiced within the scope of the following claims.

### REFERENCES

1. Black, C. T., Guarini, K. W., Milkove, K. R., Baker, S. M., Russell, T. P., Tuominen, M. T., “Integration of Self-Assembled Diblock Copolymers for Semiconductor Capacitor Fabrication”, App. Phys. Letts., 2001, 79, 409-411.
2. Skolnicki, T.; Hutchby, J A, King, T J.; Wong, H. S. P., Beouff, F., “The Road to the End of CMOS Scaling,” IEEE Circuits and Devices Magazine, 2005, 16-26.
3. Harrison, C.; Park, M.; Register, R.; Adamson, D.; Mansky, P.; Chaikin, P. “Method of Nanoscale Patterning and Products Made Thereby”, U.S. (1999), 5 pp. U.S. Pat. No. 5,948,470.
4. Nealey, P. F.; De Pablo, J. J.; Cerrina, F.; Solak, H. H.; Yang, X.; Peters, R. D.; Wang, Q. “Guided Self-assembly of Block Copolymer Films on Interferometrically Nanopatterned Substrates”, U.S. Pat. Appl. Publ. (2003), 18 pp. US 2003091752.
5. Cheng, J. Y.; Ross, C. A.; Chan, V. Z.-H.; Thomas, E. L.; Lammertink, R. G. H.; Vancso, G. I. “Formation of a Cobalt Magnetic Dot Array via Block Copolymer Lithography”, Adv. Mater., 2001, 13, 1174-1178.
6. Zschech, D.; Kim, D. H.; Milenin, A. P.; Scholz, R.; Hillebrand, R.; Hawker, C. I.; Russell, T. P.; Steinhart, M.; Gosele, U. “Ordered Arrays of <100>-Oriented Silicon Nanorods by CMOS-Compatible Block Copolymer Lithography”, Nano Leu.; 2007; 7; 1516-1520.
7. Park, M.; Harrison, C.; Chaikin, P. M.; Register, R. A.; Adamson, D. H. “Block Copolymer Lithography: Periodic Arrays of ˜10¹¹ Holes in I Square centimeter”, Science, 1997, 276, 1401-1404.
8. Bang, J.; Kim, S. H.; Drockenmuller, E.; Misner, M. I.; Russell, T. P.; Hawker, C. J., “Defect-Free Nanoporous Thin Films from ABC Triblock Copolymers”, J. Am. Chem. Soc. 2006, 128, 7622-7629.
9. Kim, S. H.; Misner, M. J.; Russell, T. P., “Solvent Induced Ordering in Thin Film Diblock Copolymer/Homopolymer Mixtures”, Adv. Mater. 2004, 16, 2119-2123.
10. Ryu, D. Y., Shin, K., Drockenmuller, E., Hawker, C. J., Russell, T. P., “A Generalized Approach to the Modification of Solid Surfaces”, Science, 2005, 308, 236-239.

1. A polymeric composition comprising a blend of A-B and B′-C block, random, branched or graft copolymers, wherein:
(i) said A-B block or graft copolymer is itself a mixture of one or more A-B block, random, branched or graft copolymers, each with at least one polymerized block or graft of polymer A and at least one polymerized block or graft of polymer B;
(ii) said B′-C block, random, branched or graft copolymer is itself a mixture of one or more B′-C block or graft copolymers, each with at least one polymerized block or graft of polymer B′ and at least one polymerized block or graft of polymer C;
(iii) the B blocks or grafts of the A-B component have attractive interactions with the B′ blocks or grafts of the B′-C component, such interactions being described by a negative Flory-Huggins parameter χ_{BB′}; and
(iv) the composition exhibits a microphase-separated, three-domain morphology with distinct A, C, and B/B′ domains comprised largely of A polymer segments, C polymer segments, and a mixture of B and B′ polymer segments, respectively.

2. The composition of claim 1 in which said A-B block, random, branched or graft copolymer is an A-B diblock copolymer and said B′-C block or graft copolymer is a B′-C diblock copolymer.

3. The composition of claim 2 in which one or both of the B and B′ blocks are themselves random or statistical copolymers comprised of two or more monomers.

4. The composition of claim 1 in which the blocks or grafts of A, B, B′, and/or C bear a group selected from olefins, conjugated dienes, methacrylates, styrenics, acrylates, acrylamides, acrylonitriles, esters, ethers, urethanes, ureas, amides, and statistical copolymers thereof.

5. The composition of claim 3 in which the A-B block or graft copolymer, as an example, is the diblock copolymer poly(methyl methacrylate)-b-poly(styrene-r-4-vinylpyridine).

6. The composition of claim 3 in which the B′-C block or graft copolymer, as an example, is the diblock copolymer poly(styrene-r-4-hydroxystyene)-b-poly(ethylene oxide).

7. A method for preparing a polymeric composition, comprising a supramolecularly interacting blend of A-B and B′-C block, random, branched or graft copolymers, wherein:
(i) said A-B block, random, branched or graft copolymer is itself a mixture of one or more A-B block or graft copolymers, each with at least one polymerized block or graft of polymer A and at least one polymerized block or graft of polymer B;
(ii) said B′-C block, random, branched or graft copolymer is itself a mixture of one or more B′-C block or graft copolymers, each with at least one polymerized block or graft of polymer B′ and at least one polymerized block or graft of polymer C;
(iii) the B blocks, random, branched or grafts of the A-B component have attractive interactions with the B′ blocks or grafts of the B′-C component, such interactions being described by a negative Flory-Huggins parameter χ_{BB′}; and
(iv) the composition exhibits a microphase-separated, three-domain morphology with distinct A, C, and B/B′ domains comprised largely of A polymer segments, C polymer segments, and a mixture of B and B′ polymer segments, respectively.

8. The method of claim 7 in which said A-B block, random, branched or graft copolymer is an A-B diblock copolymer and said B′-C block or graft copolymer is a B′-C diblock copolymer.

9. The method of claim 8 in which one or both of the B and B′ blocks are themselves random or statistical copolymers comprised of two or more monomers.

10. The method of claim 7 in which the blocks or grafts of A, B, B′, and/or C bear a group selected from olefins, conjugated dienes, methacrylates, styrenics, acrylates, acrylamides, acrylonitriles, esters, ethers, urethanes, ureas, amides, and statistical copolymers thereof.

11. The method of claim 9 in which the A-B block or graft copolymer is the diblock copolymer poly(methyl methacrylate)-b-poly(styrene-r-4-vinylpyridine).

12. The method of claim 9 in which the B′-C block or graft copolymer is the diblock copolymer poly(styrene-r-4-hydroxystyene)-b-poly(ethylene oxide).

13. The method of claim 7 wherein the A-B and B′-C block or graft copolymers are dissolved in a common solvent or solvent mixture, the solution spin-cast onto a substrate and subsequently subjected to solvent annealing with or without humidity control to develop and improve the long-range order of the microphase-separated three-domain morphology.

14. The method of claim 7 wherein the A-B and B′-C block or graft copolymers are dissolved in a common solvent or solvent mixture, the solution spin-cast onto a substrate and subsequently subjected to thermal annealing with or without humidity control to develop and improve the long-range order of the microphase-separated three-domain morphology.

15. The method of claim 13 or 14, further comprising the use of graphoepitaxial techniques to improve the in-plane order of the microphase-separated three-domain morphology and/or to align the morphology relative to the substrate.

16. The method of claim 13 or 14, further comprising removing the A, C, and/or B/B′ domains by a suitable chemical and/or physical treatment.

17. The method of claim 13 or 14, further comprising performing lithographic techniques such as etching, pattern transfer, or templating as are conventionally carried out with traditional photoresists to create a pattern on an underlying substrate.

18. An article produced by the method of claim 13 or 14.

19. An article produced by the method of claim 15 or 16.

20. An article produced by the method of claim 17.
